(19) United States
(12) Patent Application Publication
(10) Pub. No.: US 2015/0158057 A1
(43) Pub. Date: Jun. 11, 2015

(54) PROCESSING SYSTEM FOR POWDERS, AND METHOD FOR PROCESSING POWDERS

(71) Applicant: HARRO HÖFLIGER VERPACKUNGSMASCHINEN GMBH, Allmersbach im Tal (DE)

(72) Inventors: Steffen Gall, Allmersbach im Tal (DE); Oliver Rau, Allmersbach im Tal (DE); Rainer Wieland, Allmersbach im Tal (DE)

(73) Assignee: HARRO HÖFLIGER VERPACKUNGSMASCHINEN GMBH, Allmersbach im Ta (DE)

(21) Appl. No.: 14/566,965

(22) Filed: Dec. 11, 2014

(30) Foreign Application Priority Data
Dec. 11, 2013 (EP) 13 005 768.0-1703

(51) Int. Cl. B08B 9/035; B08B 9/032

(52) U.S. Cl. CPC B08B 9/035; B08B 9/0321

(57) ABSTRACT

The application relates to a processing system and to a method for processing pharmaceutical powders. The processing apparatus comprises a plurality of processing stations which are arranged in a cyclical manner. The processing system includes at least one first zone and one second zone, wherein each zone includes at least one processing station of the processing apparatus. A cleaning tunnel which encompasses at least one processing station of the second zone is included in the second zone. A first end of the cleaning tunnel adjoins the first zone. A suction installation is arranged in the region of an opposite second end of the cleaning tunnel. Using the suction installation, a purifying-gas stream is generated in the cleaning tunnel.

### CROSS-REFERENCE TO RELATED PATENT APPLICATIONS

This application is based upon and claims the benefit of priority from prior European Patent Application No. EP 13 005 768.0-1703, filed Dec. 11, 2013, the entire contents of which are incorporated herein by reference in their entirety.

### BACKGROUND

The application relates a processing system for pharmaceutical powders, including a processing apparatus for the powder, wherein the processing apparatus comprises a plurality of processing stations arranged in a cyclical manner, wherein the processing system includes at least one first zone and one second zone, wherein each zone includes at least one processing station of the processing apparatus, wherein a cleaning tunnel which encompasses at least one processing station of the second zone is arranged in the second zone, wherein a first end of the cleaning tunnel adjoins the first zone, and wherein a suction installation is disposed in the region of an opposite second end of the cleaning tunnel. This application also relates to a method for processing pharmaceutical powders involving providing the above processing system and generating a purifying-gas stream in the cleaning tunnel using the suction installation.

Often in the pharmaceutical industry highly effective powders are processed, for example, filled into hard gelatine capsules or pressed to tablet form. In appropriate concentrations such highly effective powders may have a toxic effect. Therefore, processing of such powders requires special considerations to prevent the machine operator and the environment from becoming overly exposed or endangered.

Previously, such powders were processed either in isolated rooms and/or by machine operators who were equipped with special protective gear. The effort required to protect operators or others who may be exposed was large and cost-intensive and included for example using full protective clothing and/or isolating the machinery by using a tightly sealed housing for accommodating processing apparatuses. In such systems, freedom of movement of the machine operator and access to the processing apparatus would be significantly restricted.

Particularly problematic was the contamination of the interior space of the closed housing and of the machine parts disposed therein by unavoidable pulverulent residues. After the completion of a production cycle and prior to accessing the interior space of the housing, intensive cleaning was required to remove such pulverulent residues. To this end, previous powder processing required intensive rinsing with water with the optional addition of cleaning. The process would then require testing of the rinse water run off for pulverulent component parts, and only when a sufficiently low concentration was established would the housing door be opened for access to the processing apparatus located in the interior space of the housing. Such a process is described as “washing in place” (WiP). In a complementary manner to the intensive rinsing with water in the case of the WiP method, foam which is sprayed on and which creeps into hard-to-reach corners and, on account thereof, facilitates the release and rinsing off of pulverulent residues may also be employed.

The WiP method requires specially designed machines having housings which are correspondingly closed. Both machine and housing have to be absolutely tight, in particular in relation to the rinsing water being employed, so that no contaminated rinsing water may leak. Given the multiplicity of the moving parts, this is difficult to implement, because not only the housing and its door but also the moving parts of the processing apparatus including the shaft bearings, actuation ducts, and the like have to be reliably sealed. As a result, standardized machines cannot be employed, and adapting the processing apparatus to changing production requirements is therefore difficult and complex. Production is as a result inflexible and involves high operational costs. Apart from the high investment costs in plant and equipment, the WiP process also involves high costs associated with disposing the rinse water run off.

In addition to the above, further problems arise when individual processing stations within a processing apparatus inevitably malfunction. For example, in the case of capsule-filling machines, jamming and other like problems arise due to dimensional variations and/or defects in the supplied empty capsules. In such situations the constrains imposed when using the WiP process and the need to avoid contamination of the processing apparatus mean that the malfunctions cannot be addressed using simple gloves or other simple protective measures. There is therefore a demand for a simple and uncomplicated apparatus and associated method of access that permits an operator to rapidly rectify malfunctions, while simultaneously adhering to the requirements of operator safety.

### SUMMARY OF PREFERRED EMBODIMENTS

It is therefore one object of the present application to provide a processing system for in particular pharmaceutical powders, which is cost-effective, is flexible in the production process, and is easy to manage without endangering humans and the environment.

It is another object of the present application to provide a method for processing in particular pharmaceutical powders by means of a processing system which can be carried out easily and with low complexity, while maintaining the protection of humans and the environment.

This and other objects are achieved by the subject matter of the present application.

In an exemplary embodiment, the application describes processing systems in which the processing apparatus includes a plurality of processing stations that are arranged in a cyclical manner. The processing apparatus is divided into various zones having different loadings of dust or contamination, respectively. The processing system includes at least one first zone and one second zone, wherein each zone includes at least one processing station of the processing apparatus. In the said embodiment, the first zone, for operational reasons, has the lowest individual incidence of dust and/or contamination, and may be accessed by an operator even without protective measures as long as an introduction of dust and/or contamination from the adjacent second zone, which is loaded to a higher extent, can be avoided.

Furthermore, said embodiment includes a cleaning tunnel that engages over at least one processing station of the second zone. The cleaning tunnel has two opposite ends, wherein a first end of the cleaning tunnel is adjacent to the first zone, and a suction installation is arranged in the region of the second end. In an embodiment of a corresponding operating method, using the suction installation, a purifying-gas stream is generated in the cleaning tunnel. A technical gas may be employed for the purifying-gas stream. The purifying-gas stream is preferably a purifying-air stream.

In another embodiment, the purifying-air stream is configured such that it swirls and/or raises from the processing stations dust and other contaminants in the region of the processing stations located in the cleaning tunnel. The cleaning tunnel thus removes the dust and other contaminants and prevents the same from being distributed throughout the entire processing system. Rather, the particles of dust and other containments remain within the purifying tunnel, are carried away by the purifying-air stream, and are removed at the end of the cleaning tunnel by the suction installation. In such an embodiment, the cleaning tunnel permits effective particle removal such that more intensive cleaning measures, including utilization of a “washing in place” (WiP) process, may optionally be omitted.

In yet another embodiment, the processing system prevents carryover of particles from the more highly loaded second zone into the less loaded first zone by utilizing a suction installation at that end of the cleaning tunnel, which is opposite to the end which adjoins the first zone. The purifying-gas stream or the purifying-air stream, respectively, thus flows away from the first, less loaded zone, such that individual dust or contaminant particles cannot flow counter to the gas stream and into the first zone. Accordingly, access to the less loaded first zone by the operating personnel is possible without further protective measures, especially when the suction installation is running. In said embodiment, by dispensing with interventions while wearing a glove or other protective measures, rectifying disturbances or other interventions at the processing stations of the first zone is/are readily possible.

In yet another preferred embodiment, the processing apparatus includes a conveying device having one direction of movement. One embodiment of such a conveying device is a turntable, but such conveying device may also be an oval conveyor, a revolving conveyor belt, or the like, by way of which, for example, a capsule holder or other target containers, such as blister packs or similar, for the purpose of a metering and filling process are cyclically displaced from one processing station to another. The suction installation here is advantageously disposed on the second end of the cleaning tunnel which lies opposite the direction of movement. During operation, the purifying-gas stream here flows counter to the direction of movement of the conveying means. On account of the counter movement mentioned, it is ensured that the elements moved by the conveying means, such as container receptacles or capsule receptacles, respectively, or similar, are purified in the cleaning tunnel and subsequently also maintain their purified state until they make their way into the less loaded first zone. Carryover of particles from the second zone into the first zone is thus reliably avoided.

In still yet a further embodiment, at least one blower nozzle which is directed into the cleaning tunnel and toward the suction installation is provided. Using this at least one blower nozzle, a directed blowing stream having a directional component in the direction of the purifying-gas stream is generated. One or more blower nozzles may also be disposed outside the cleaning tunnel and directed into the end of the cleaning tunnel that, when viewed in the direction of flow, is on the entry side. Preferably, however, the blower nozzles are arranged inside the cleaning tunnel and blow in the direction of the suction installation. A plurality of blower nozzles which are distributed in the longitudinal direction and/or in the circumferential direction of the cleaning tunnel may also be provided. By way of a suitable orientation of the blower nozzles, particular, suitable points of the respective processing station can be blown down in a targeted manner. Moreover, the mentioned directional component supports the configuration of the purifying-gas stream in the provided direction pointing away from the first zone.

In another embodiment, at least the second zone is enclosed by a housing, and includes a device that generates a pressure differential between the second zone and the first zone in such a manner that, during operation, the pressure in the second zone is less than a pressure of the first zone. The processing system may optionally also include an additional third zone having at least one processing station, wherein the third zone is enclosed by a housing. In this case, a second device for generating a pressure differential between the third zone and the second zone is provided and configured in such a manner that, during operation, the pressure in the third zone is less than the pressure in the second zone.

In still a further embodiment, a cascading pressure differential between the various zones is created, wherein the highest pressure prevails in the surrounding region of the first zone, and wherein, in relation thereto, the second internal pressure is less. The third internal pressure of the third zone, if the latter is present, is then even lesser. A complete sealing of the corresponding housings may be dispensed with here, because air from the surroundings follows the cascading pressure differential through defects in air tightness, gaps, or the like, and flows from the least loaded first zone to the more highly loaded second zone and from there to the even more highly loaded third zone. Accordingly, dust particles or other contaminants do not disseminate or flow through gaps and/or defects counter to this pressure differential, and do not make their way into the first zone. As a result, the first zone is not compromised or contaminated by the high load of contaminants of the second or third zones, respectively, and may be left without particular protective measures. Of course, in another embodiment, it is also possible for the first zone to be provided with its own housing, wherein a pressure differential in relation to the atmospheric external pressure is generated by way of a reduced first internal pressure. In the case that the pressure in the surrounding region of the first zone is equal to the atmospheric external pressure, a housing for the first zone may then optionally be dispensed with. In any case, however, easy access from the outside to the processing stations of the first zone is possible.

In still another embodiment, any constructive types, such as tablet presses or similar, may be considered as a processing system for powders in the context of the application. The processing apparatus may be, in particular, a capsule-filling installation, wherein at least one processing station of the first zone is an empty-capsule supply station, wherein at least one processing station of the second zone is a capsule-closing station and/or a capsule-ejecting station, and wherein in particular one processing station of the third zone is a powder-metering station and/or powder-filling station. It such a configuration the advantages of the application particularly come to bear. In this configuration, the highest degree of contamination prevails in the third zone, which should be kept apart from the lesser contamination of the second zone. Of the three zones, the empty-capsule supply station of the first zone displays the lowest incidence of contamination, on the one hand, while on the other hand requires the highest degree of manual intervention. In conjunction with the cleaning tunnel according to the application and in particular the pressure cascade mentioned above, simple intervention without particular protective measures is possible in the first zone.

In yet a further embodiment, the processing system comprises at least one first system portion and at least one second system portion, wherein the processing apparatus for the powder is divided into at least one first device portion and at least one second device portion. The first zone, mentioned above, is included in the first system portion, while the second zone and, in particular, also the third zone are included in the second system portion. The first and the second system portions in each case include a closed housing having an outer side and an, wherein the first device portion is arranged in the interior space of the first housing, and the second device portion is arranged in the interior space of the second housing. The first system portion is arranged so as to be stationary, while the second system portion is configured so as to be mobile. The second system portion is coupleable to the first system portion and decouplable therefrom by means of a lock. In an exemplary embodiment of a corresponding method, the second system portion is decoupled from the first system portion and, with the lock closed, is forwarded to a separate cleaning operation. As a consequence of the construction manner which, on account thereof, is modular and partly mobile, the first system portion having the slightly contaminated first zone may remain in place, wherein after decoupling of the second, mobile system portion, maintenance works or conversion works, for example, may be performed without a comparatively large cleaning and protective effort on the first stationary system portion. The decoupled second system portion having the more highly contaminated second and third zones may be transported without risk when the lock is closed and may be subjected to intensive cleaning, for example by way of washing, at a suitable point, without activities on the first system portion being compromised on account thereof.

Further objects, features, and advantages of the present application will become apparent from the detailed description of preferred embodiments which is set forth below, when considered together with the figures of drawing.

### BRIEF DESCRIPTION OF THE DRAWINGS

Exemplary embodiments of the application are described in more detail below by means of the figures of drawing, in which:

FIG. 1 in a schematic plan view, shows the in-principle construction of a processing system according to the application, having various zones, processing stations, and a cleaning tunnel;

FIG. 2 in a perspective and enlarged sectional illustration, shows the arrangement as per FIG. 1 in the region of a single processing station, with details of the cleaning tunnel surrounding said processing station;

FIG. 3 in a schematic sectional illustration, shows the in-principle construction of a processing system according to the application, having installations for dry decontamination, in the form of suction, blowing down, and powder binding;

FIG. 4 shows a variant of the arrangement as per FIG. 3, having one stationary and one mobile system portion, wherein the installations for dry decontamination are provided for the stationary system portion;

FIG. 5 shows the arrangement as per FIG. 4, having system portions, which have been decoupled from one another, for dry decontamination of the stationary system portion, and separate decontamination of the mobile system portion.

### DETAILED DESCRIPTION OF PREFERRED EMBODIMENTS

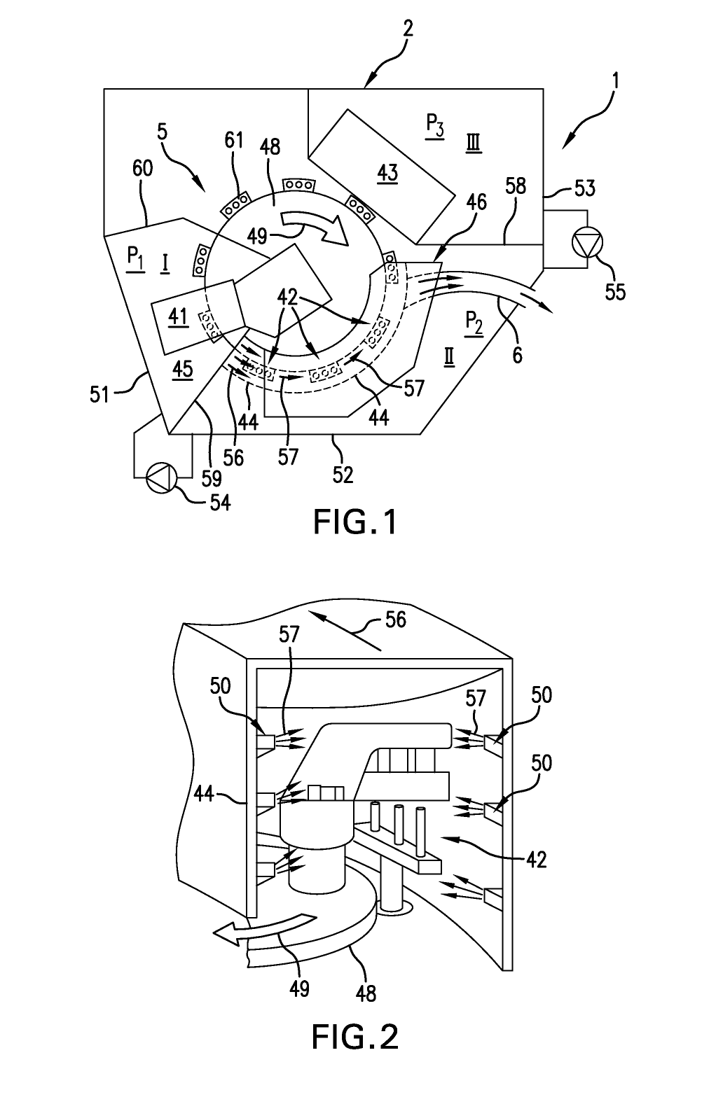

FIG. 1, in a schematic plan view, shows the in-principle construction of a processing system 1, according to the application, for in particular pharmaceutical powders. The term “powder” in the sense of the application does not only mean fine-grained dry substances, but also comprises granular-type materials and other materials in the processing of which powder-type dust may be released. The processing system 1 shown in an exemplary manner is provided for processing highly effective pharmaceutical powders having high concentrations of active ingredients, wherein such a highly effective powder in corresponding doses may be incompatible or even toxic. The subject matter of the present application is designed to protect the operator and the environment from such undesirable side effects, and is described herein in more detail by way of exemplary embodiments.

The processing system 1 comprises a housing 2 and a processing apparatus 5 arranged therein for processing a powder. The processing apparatus 5 comprises at least two processing stations 41, 42, which are arranged cyclically in the processing system 1. The embodiment of FIG. 1 includes a total of nine processing stations 41, 42, 43. The processing system 1 is divided into at least one first zone I and one second zone II, and optionally into a third zone III. The first zone I includes at least one processing station 41, while the second zone II includes at least one further processing station 42. The optional third zone III also includes at least one processing station 43. The inside of housing 2, has separation walls 58, 59, 60, such that interior spaces which are separate from one another are created and form individual housings 51, 52, 53. The housing 51, which is provided only in an optional manner, encloses the first zone I, while the further second housing 52 encloses the second zone II. Finally, the optional third zone III is also enclosed by a third housing 53.

The processing apparatus 5 shown may be a tablet press, a filling station for blister packs, or any other processing apparatus for powders. In the exemplary embodiment shown, the processing apparatus 5 is a capsule-filling apparatus in which a processing station 41 of the first zone I is an empty-capsule supply station. One of the processing stations 42 of the second zone II is a capsule-closing station, while a further processing station 42 of the second zone II, according to the schematic illustration as per FIG. 2, is a capsule-ejecting station. The processing station 43 of the third zone III is a powder-metering station and powder-filling station in which empty lower parts of capsules are filled with powder. Beyond this, further processing stations not described in more detail here may still be provided in all zones I, II, III.

The processing apparatus 5 displays, for example, a conveying device for the target container which is to be filled with the powder, by way of which the individual processing stations 41, 42, 43 are cyclically visited in the direction of movement 49 which is indicated by an arrow. In the exemplary embodiment shown, the conveying means is a turntable 48, but may also be an oval conveyor or a revolving conveyor belt or a revolving conveyor chain, respectively. Corresponding to the maximum possible number of, in the present case, an exemplary nine processing stations 41, 42, 43, here a total of nine retaining devices for the target containers, an exemplary nine segment carriers 57 for capsules, are fastened on the turntable 48 and, conjointly therewith, moved in a direction of movement 49 which is indicated by an arrow.

Corresponding to the illustration as per FIG. 1, a cleaning tunnel 44 having a first end 45 and a second end 46 is disposed in the second zone II. The first end 45 of the cleaning tunnel 44 adjoins the first zone I, while the opposite second end 46, in relation to the longitudinal direction of the cleaning tunnel 44, points away from the first zone I. A suction installation 6 disposed in the region of the second end 46 suctions off the interior space of the cleaning tunnel 44 during operation. The cleaning tunnel 44 spans and encompasses at least one processing station 42 of the second zone II, in FIG. 1 all processing stations 42 which, counter to the direction of movement 49 of the turntable 48, lie between the first zone I and the third zone III. During operation, by means of the suction installation 6, a purifying-gas stream 56, here a purifying-air stream, is generated in the cleaning tunnel 44, in that air which is slightly loaded or not at all loaded is suctioned in from the first zone I through the first end 45, is guided on the inner side of the cleaning tunnel 44, and is suctioned off in the region of the second end 46. FIG. 1 also shows that the second end 46 having the suction installation 6 disposed thereon creates a suction in the direction of flow through the cleaning tunnel 44, counter to the direction of movement 49 of the turntable 48, and that suction installation 6 is arranged downstream of which the purifying-gas stream 56, which runs counter to the direction of movement 49 of the conveying means or of the turntable 48.

It can be moreover obtained from the illustration as per FIG. 1 that a device 54 for generating a first pressure differential between the second zone II and the first zone I is provided as part of the processing system 1, for example a pump as shown. In an analogous manner thereto, a second device 55 for generating a second pressure differential between the third zone III and the second zone II is also optionally provided, for example a pump as shown. The first device 54 for generating the pressure differential is configured and also utilized during operation in such a manner that an internal pressure p₂ which is smaller than a pressure p₁ in the first zone I is established in the housing of the second zone II. In turn, the pressure p₁, by suitable means, may be smaller than the atmospheric external pressure pₐ. Preferably, the pressure p₁ in the surrounding region of the first zone I is equal to the atmospheric external pressure pₐ. The second device 55 for generating the pressure differential is configured and also utilized during operation in such a manner that a third internal pressure p₃ which is smaller than the second internal pressure p₂ in the housing 52 of the second zone II is established in the housing 53 of the third zone III. Overall, a descending pressure cascade having p₃<p₂<p₁<pₐ can be adjusted in this way.

FIG. 2, in a perspective and enlarged sectional illustration, shows the arrangement as per FIG. 1, in the region of one of its second processing stations 42 of the second zone II, with details of the cleaning tunnel 44 surrounding the second processing stations 42. The cleaning tunnel 44 displays a substantially closed cross section which is formed by the base of the processing system 1, by side walls and by a cover. The closed cross section is interrupted in a merely minor manner only there where the turntable 48 extends into the interior space of the cleaning tunnel 44. However, according to the application, this and other comparatively small interruptions of the otherwise closed tunnel cross section are to be contained such that the aforementioned cleaning stream 56 within the cleaning tunnel 44 is established with gas exchange with the outer side of the cleaning tunnel 44 being small or negligible with respect to the cleaning effect.

It can also be obtained from the illustration as per FIG. 2 that at least one blower nozzle 50, here a plurality of blower nozzles 50, is disposed in a complementary manner to the suction installation 6 as per FIG. 1. The blower nozzles 50 with their blowing stream are directed onto points to be blown clean of the adjacent processing station 42, on the one hand, and into the cleaning tunnel 44 and toward the suction installation 6, on the other hand. During operation, in each case a blowing stream 57 is created having a directional component in the direction of the purifying-gas stream 56, on account of which, apart from the cleaning effect, also supports the purifying-gas stream 56.

Corresponding to the illustration as per FIG. 2, a plurality of blower nozzles 50, here an exemplary six, are distributed in the circumferential direction of the cross section of the cleaning tunnel 44. Alternatively or additionally, corresponding to the illustration as per FIG. 1, also a plurality of blower nozzles 50 are distributed in the longitudinal direction of the cleaning tunnel 44 and are in each case assigned to a processing station 42.

In the exemplary embodiment as per FIG. 1 and FIG. 2, the cleaning tunnel 44 is shown and described interacting with the separation walls 58, 59, 60 and devices 54, 55 in order to generate pressure differentials or pressure cascades, respectively. The cleaning tunnel 44 according to the application may however also be employed without such devices in a processing system 1 in the interior space of which a uniform pressure prevails without pressure differentials, wherein this internal pressure may also be equal to the atmospheric surrounding pressure pₐ. It is in any case achieved that the first zone I is kept free from contaminating particle carryovers from the second zone II and/or the third zone III. The level of contamination in the first zone I can be kept so low that, if and when required, operators may access the processing stations 41 without particular measures for operator safety.

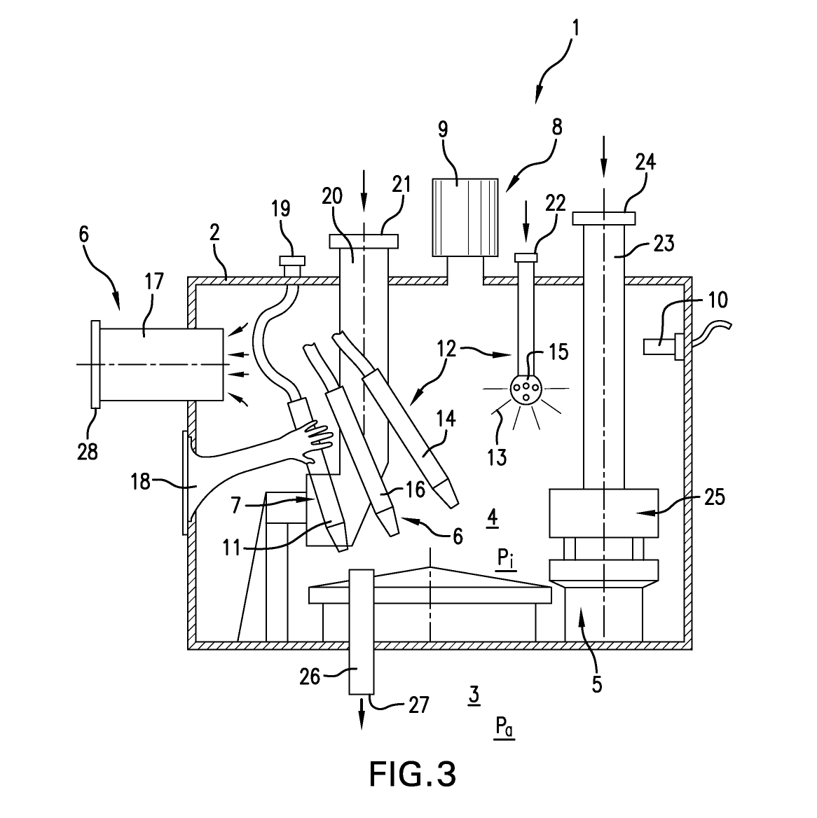

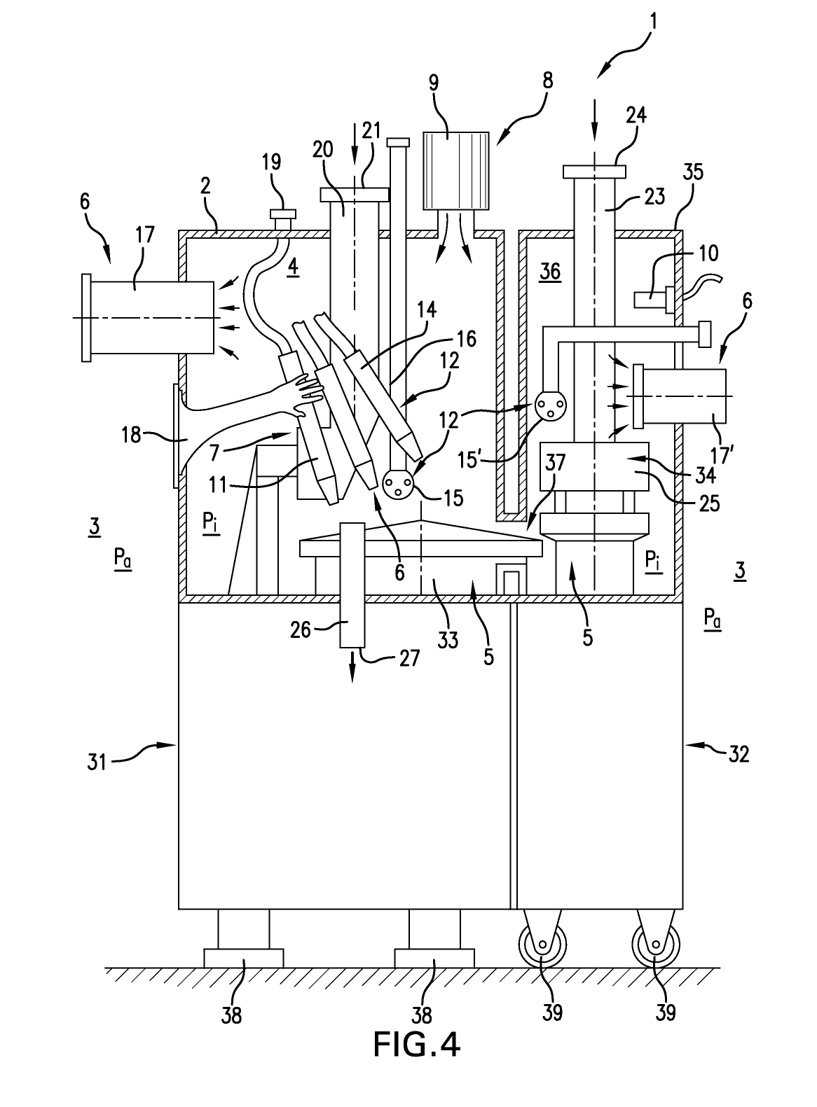

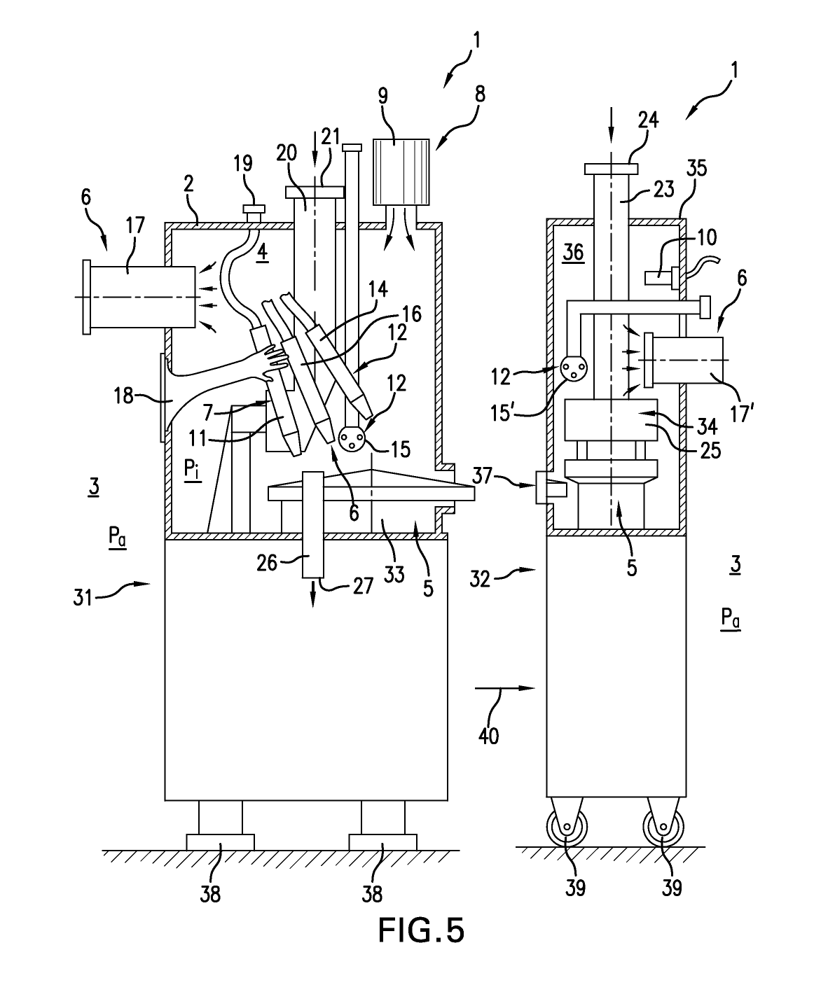

FIGS. 3 to 5 show even further exemplary embodiments of processing systems 1 for powders, including further details of the application that may be individually employed as shown and described in the following but may also employed in any combination with the arrangement as per FIGS. 1 and 2. It may be expedient, in particular, for the processing system 1 as per FIGS. 1 and 2 to comprise at least one first system portion 31 and at least one second system portion 32, corresponding to the exemplary embodiment as per FIGS. 4 and 5, described further below, wherein the processing apparatus 5 for the powder is divided into at least one first device portion 33 and at least one second device portion 34. Corresponding to the comparative viewing of FIGS. 1, 2, 4, and 5, the first zone I here is then assigned to the first system portion 31, and the second zone II and, in particular, also the third zone III are assigned to the second system portion 32. Here, the first and the second system portions 31, 32 in each case display one closed housing 2, 35 having an outer side 3 and having in each case one first or second, respectively, interior space 4, 36, wherein the first device portion 33 is disposed in the interior space 4 of the first housing 2, and the second device portion 34 is disposed in the interior space 36 of the second housing 35. The first system portion 31 is arranged so as to be stationary. The second system portion 32 is configured so as to be mobile. The second system portion 32 is coupleable to the first system portion 31 and decouplable therefrom using a lock 37 or the like, as is described in more detail further below in the context of FIGS. 4 and 5. In a corresponding embodiment of a method, the second system portion 32 is decoupled from the first system portion 31 and, with the lock 37 closed, is removed to a separate cleaning operation in the case of cleaning and/or maintenance or conversion requirements, respectively.

FIG. 3, in a schematic sectional illustration, shows a further exemplary embodiment of a processing system 1 for powders, according to the application. The processing system 1 comprises a closed housing 2 having an outer side 3 and an interior space 4, and a processing apparatus 5 for the powder, which is disposed in the interior space 4 of the housing 2. The housing 2 is closed in the sense that during processing operations no immediate access from the outside to the processing apparatus 5 is possible. However, the housing 2 is not completely sealed against entry of air, water or similar. In particular, the processing apparatus 5 also does not display any particular sealing measures on its moving parts against the entry of air or water or similar, so that any standardized processing apparatus 5 may be employed. In the exemplary embodiment shown, the processing apparatus 5 is a capsule-filling installation having a metering station 25 which meters and fills powder into capsules. However, a tablet press or the like may also be provided.

In detail, besides the metering station 25 the capsule-filling installation comprises an empty-capsule supply 20, a powder supply 23 and a capsule outlet 26 for completely filled and closed capsules. The empty-capsule supply 20 and the powder supply 23 lead from the outer side 3 into the interior space 4 and, on the outer side 3, are provided with couplings 21, 24. The capsule outlet 26 is led from the interior space 4 through the wall of the housing 2 to the outer side 3, and on the outer side 3 displays an interface 27. The couplings 21, 24 and the interface 27 are designed in such a manner that material may indeed be guided therethrough, however without powder which has been set free during operation being able to reach the outer side 3 from the interior space 4.

Moreover, the processing system 1 is equipped with an installation for dry decontamination and, to this end, comprises a suction installation 6 for the interior space 4, and a compressed-air rinsing installation 7. Moreover, a controlled air supply 8 having an air filter 9, a spraying installation 12 for a powder-binding agent 13, a particle sensor 10 for monitoring the interior space for powder residues, and a gloved intervention element 18 are provided for dry decontamination.

The compressed-air rinsing installation 7 may comprise an arrangement of stationary compressed-air nozzles, and in the exemplary embodiment shown display a manually guided air-rinsing nozzle 11 which is disposed in the interior space 4 and which is provided using a supply hose connected to coupling 19 arranged on the outside and connected to compressed air. The spraying installation 12 comprises a binding-agent spray head 15 having an associated coupling 22, which is fastened in a stationary manner in the housing 2, and also comprises a manually guided binding-agent spraying nozzle 14 disposed in the interior space 4. The suction installation 6 comprises a stationary suction 17, having an interface 28 which lies on the outside, which is led through the wall of the housing 2, and optionally also a manually guided suction nozzle 16 which is disposed in the interior space 4. The same as has been described further above in the context of the couplings 19, 24 and the interface 27 applies to the design of the couplings 19, 22 and the interface 28. Using the gloved intervention element 18, the machine operator standing on the outer side 3 has access to the air-rinsing nozzle 11, the binding-agent spraying nozzle 14 and/or the suction nozzle 16. Because the binding-agent spraying nozzle 14 or the suction nozzle 16, respectively, are supplied by corresponding hose lines (not illustrated) leading to the outside in a manner comparable to the air-rinsing nozzle 11, the machine operator can grip the mentioned nozzles and guide them to any point, including all individual parts of the processing apparatus 5, in the interior space 4.

During operation or in the operational method according to one embodiment of the application, the powder is processed using the processing apparatus 5 which is disposed in the interior space 4 of the housing 2. In an exemplary manner, this is carried out in that empty capsules are supplied by way of the empty-capsule supply 20, are filled with powder in the metering station 25, and, in the filled and closed state, are discharged by way of the capsule outlet 26. During processing, an internal pressure pᵢ which is smaller than an external pressure pₐ on the outer side 3 of the housing is maintained in the interior space 4 using the suction installation 6, namely by using stationary suction 17. The external pressure pₐ is usually the atmospheric ambient pressure. As a result of the pressure differential created, air is suctioned in from the outer side 3 into the interior space 4 via defects in the air tightness present in the housing 2, subsequent to which, on account of the mentioned defects in the air tightness, no powder can flow from the interior space 4 to the outer side 3 in a manner counter to the air stream created. In addition to the leakage air stream entering as a result of the mentioned defects in the air tightness, filtered air is led into the interior space 4 by way of the controlled air supply 8, subsequent to which a specific internal pressure pᵢ or a specific pressure differential, respectively, in relation to the external pressure pₐ can be adjusted and maintained.

For maintenance, conversion and adaptation works, in particular on the processing apparatus 5, decontamination of the interior space 4 including the processing apparatus 5 or parts thereof, respectively, disposed therein, by way of removal of present powder residues is required after the conclusion of the processing of a powder. For such a decontamination operation, the amount of gas conveyed into the interior space 4 by compressed-air rinsing installation 7 is less than the amount of gas conveyed out of interior space 4 by suction installation 6 such that the internal pressure pᵢ remains smaller than the external pressure pₐ. During decontamination, the conveying performance of the suction installation 6 and of the compressed-air rinsing installation 7 are thus tuned in relation to one another in such a manner that during simultaneous operation of the suction installation 6 and of the compressed-air rinsing installation 7 the above pressure conditions are created or are maintained. Using the compressed-air rinsing installation 7, in particular by way of manual guiding of the air-rinsing nozzle 11, adhering powder residues are blown down from all surfaces using compressed air. The raised powder residues are suctioned together using air from the interior space 4 using the suction installation 4. To this end, the stationary suction 17 may suffice. Targeted suctioning may be performed in a complementary manner by using the manually guided suction nozzle 16 at specific points.

It is provided as a further method step according to one embodiment of the application that during the decontamination process, a powder-binding agent 13 is sprayed using spraying installation 12, located in the interior space 4 and the processing apparatus 5 or parts thereof. As a result, powder residues adhering on the surfaces and also raised powder particles on the respective surfaces are bound, without being able to become dislodged again. Foam, water vapor, a mist of water droplets and/or a gel may be employed as powder-binding agents. Delivery of the powder-binding agent 13 preferably takes place while an internal pressure pᵢ, which is smaller than the external pressure pₐ on the outer side 3, prevails in the interior space 4 of the housing 2. However, in particular in the case of less critical substances, this method step may also be performed while an internal pressure pᵢ, which is at least approximately equal to the external pressure pₐ, of the outer side 3 of the housing 2 prevails in the interior space.

In an embodiment, the process of spraying a powder-binding agent 13 described above, and thus the binding of powder residues may be employed in combination with the combined suction-and-blow cleaning process described previously. In particular, initially suction-and-blow cleaning takes place, subsequently followed by binding dust using the powder-binding agent 13. However, it may also be expedient for only the binding of powder residues using the powder-binding agent 13 to be carried out, while dispensing with a combined suction-and-blow cleaning.

The interior space 4 is monitored for freely suspended powder particles by means of the particle sensor 10. As soon as this monitoring has determined that a predefined limit amount of raised and suspended powder residues has been undershot, it is determined that the preceding suction-and-blow cleaning and/or the binding of free powder particles has been successful in such a way that the negative pressure in the interior space 4 can be switched off and the housing 2 can be opened without a risk. In the case of the binding of dust, cleaning or removal, respectively, of the powder bound using the powder-binding agent 13 can now be performed. The bound powder may be wiped off. In the case of the binding using a gel, a film having the powder residues bound therein is formed after drying the gel, wherein the dried film can be peeled off from the surface. Removal of the bound powder may however also be performed already with the housing 2 closed and the pressure differential in place, by means of the gloved intervention element 18, for example. In any case, a signal indicating that access to the interior space 4 is possible without risk is generated. Maintenance, conversion and adaptation works may be performed on the processing apparatus 5.

FIG. 4, in a schematic sectional illustration, shows a variant of the arrangement as per FIG. 3, in which the processing system 1 is divided into a stationary first system portion 31 and a mobile second system portion 32. Additional stationary and/or mobile system portions may be provided in a complementary manner. The first stationary system portion 31 is arranged so as to be stationary by utilizing support feet 38, and corresponding to the exemplary embodiment as per FIG. 3, displays a closed first housing 2 having a first interior space 4. The second system portion 32 is configured in the form of a displaceable or mobile trolley having casters 39 or wheels, and, in an analogous manner to the first system portion 31, comprises an independent, second closed housing 35 having a second interior space 36. The processing apparatus 5 corresponds to the processing apparatus 5 as per FIG. 3, but here is divided into a first device portion 33 and a second device portion 34. The first device portion 33 comprises the empty-capsule supply 20 and the capsule outlet 26, and is arranged in the first interior space 4 of the first housing 2. The second device portion 34 comprises the powder supply 23 and the metering station 25, and is arranged in the second interior space 36 of the second housing 35. In the optional case not illustrated, additional stationary and/or mobile system parts having a comparable construction, which in each case include a dedicated housing and a device portion of the processing apparatus 5 disposed in the interior space of the housing, may be provided.

The second mobile system portion 32 is embodied as an exchangeable module and, depending on requirements, is coupleable to the first system portion 31 and also decouplable therefrom using a lock 37 or the like. For processing the powder, the mobile second system portion 32 is coupled to the first stationary system portion 31 using the lock 37, according to the illustration as per FIG. 4, wherein mechanical coupling elements (not illustrated) are present for the accurate positioning, retaining and connecting of the second system portion 32 to the first system portion 31. Here, the first device portion 33, together with the second device portion 34, forms the entire processing apparatus 5. The first interior space 4 and the second interior space 36 are connected to form a common interior space using the opened lock 37. Connecting of the interior spaces 4, 36, and the two device portions 33, 34 takes place by way of the opened lock 37.

According to the embodiment as per FIG. 3, the suction installation 6 having the stationary suction 17 and the manually guided suction nozzle 16, the compressed-air rinsing installation 7 having the manually guided air-rinsing nozzle 11, the air supply 8 having the air filter 9, the particle sensor 10, the rinsing installation 12 having the manually guided binding-agent spraying nozzle 14 and the stationary binding-agent spray head 15, and the gloved intervention element 18 are arranged in the stationary first system portion 31. The optional particle sensor 10 is disposed in the interior space 36 of the second housing 35. Moreover, the second system portion 32 is provided with an additional binding-agent spray head 15′ as part of the spraying installation 12, and with an additional suction 17′ as part of the suction installation 6.

The processing of the powder using the processing apparatus 5 takes place in another embodiment as described in the context of FIG. 3, wherein an internal pressure pᵢ which is smaller than the external pressure pₐ on the outer side 3 of the housings 2, 35 is maintained in the connected interior space using the suction installation 6. Naturally, there is a higher dust load in the mobile second system portion 32, having the powder supply 23 and the metering station 25, than in the first system portion 31, having the empty-capsule supply 20 and the capsule outlet 26. Because the two interior spaces 4, 36 are only connected to one another using the lock 37 or the like, carryover of the higher dust or powder load, respectively, in the second interior space 36 to the first interior space 4 is reduced to a minimum.

In preparation of a subsequent decontamination process, the second system portion 32 is decoupled from the first system portion 31, as is illustrated in FIG. 5. Here, the interior space 36 of the second housing 35 is closed off using the lock 37. The associated passage on the first interior space 4 may optionally be closed off in the same way. On account of the closed lock 37, the second interior space 36 of the second system portion 32 is closed off in a way that the product present therein is protected when the decoupled first system portion 31 is accessed. In an analogous manner to the description of the arrangement as per FIG. 3, to this end the second housing 35 and the lock 37 do not need to be completely air-tight and dust-tight. It may suffice for a reduced internal pressure pᵢ to be maintained by means of the associated suction 17′, so that no powder or dust, respectively, might leak to the outside through any potentially present defect of air tightness. The second system portion 32 which has been separated in this way may be removed on its casters 39 from the first system portion 31, in a corresponding manner to an arrow 40, so that free access to the first system portion 31 is possible.

For conversion or maintenance works, and for the remedy of faults, dry decontamination is now performed on the free-standing first system portion 31, while the second system portion 32 is decoupled. Dry decontamination of the first system portion 31 takes place by combined suctioning and blowing by means of the suction installation 6 and the compressed-air rinsing installation 7 and/or by way of the employment of a powder-binding agent 13 (FIG. 3) using the spraying installation 12, as is described in detail in the context of FIG. 3. Upon dry decontamination having been performed, the machine operator may access the interior space 4 and the first device portion 33, disposed therein, of the first system portion 31 without risk. Subsequently, the second system portion 32 may be moved up to the first system portion 31 again and be coupled thereto in a corresponding manner to the illustration as per FIG. 4, on account of which the processing system 1 is put into an operationally ready state. The processing of the powder can be reinitiated in the way described above.

However, it is also possible for the second system portion 32, which has been decoupled as per FIG. 5, to be subjected to dedicated decontamination. To this end, dry decontamination may be performed by employing, for example, the binding-agent spray head 15′ in the way described above. It is likewise possible for a stand-alone compressed-air rinsing installation (not illustrated) to be provided to this end, besides the suction installation 6 which is in any case present. Because of the increased degree of contamination as compared with the first system portion 31 and the poorer accessibility of the second device portion 34 under certain circumstances, it may, however, also be expedient for the second system portion 32 to be displaced into a protected cleaning room which is specifically provided therefor, where the second system portion 32 is subjected to intensive decontamination, for example, employing full personal protective gear. Instead of the standardized, not specially sealed and thus not WiP-compatible second device portion 34, here remains also the possibility of selecting a design of the second system portion 32 which is overall WiP-compatible, on account of which the increased contamination can be removed by way of intensive wet decontamination.

The foregoing description of preferred embodiments has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

1. A processing system for pharmaceutical powders, comprising a processing apparatus for the powder, wherein the processing apparatus comprises a plurality of processing stations arranged in a cyclical manner, wherein the processing system includes at least one first zone and one second zone, wherein each zone includes at least one processing station of the processing apparatus,
wherein a cleaning tunnel which encompasses at least one processing station of the second zone is arranged in the second zone, wherein a first end of the cleaning tunnel adjoins the first zone, and wherein a suction installation is disposed in the region of an opposite second end of the cleaning tunnel.

2. The processing system according to claim 1,
wherein the processing apparatus includes a conveying device, wherein the conveying device has a direction of movement, and wherein the suction installation conveys gas in a direction opposite the direction of movement of the conveying device.

3. The processing system according to claim 1, further comprising at least one blower nozzle which is directed into the cleaning tunnel and toward the suction installation.

4. The processing system according to claim 3, further comprising a plurality of blower nozzles which are distributed in the longitudinal direction or in the circumferential direction of the cleaning tunnel are provided.

5. The processing system according to claim 1, wherein at least the second zone is enclosed by a housing, further comprising a pump for generating a pressure differential between the second zone and the first zone, wherein during operation a second internal pressure of the second zone prevails inside the housing of the second zone and is smaller than a pressure of the first zone.

6. The processing system according to claim 5,
further comprising a third zone having at least one processing station, wherein the third zone is enclosed by a housing, further comprising a second pump for generating a pressure differential between the third zone and the second zone, wherein during operation a third internal pressure of the third zone prevails inside the housing of the third zone and is smaller than a pressure of the second zone.

7. The processing system according to claim 1, wherein the processing apparatus is a capsule-filling installation, wherein at least one processing station of the first zone is an empty-capsule supply station, wherein at least one processing station of the second zone is a capsule-closing station and/or a capsule-ejecting station, and wherein in particular one processing station of the third zone is a powder-metering station and/or a powder-filling station.

8. The processing system according to claim 1, wherein the processing system comprises at least one first system portion and at least one second system portion, and wherein the processing apparatus for the powder is divided into at least one first device portion and at least one second device portion, wherein the first zone is assigned to the first system portion, and the second zone and a third zone are assigned to the second system portion, wherein the first and the second system portion are each enclosed by a closed housing having an outer side an interior space, wherein the first device portion is disposed in the interior space of the first housing, and the second device portion is disposed in the interior space of the second housing, wherein the first system portion is arranged so as to be stationary and the second system portion is configured so as to be mobile, further comprising a lock for coupling and uncoupling the second system portion to the first system portion.

9. A method for processing pharmaceutical powders comprising providing the processing system according to claim 1 and generating a purifying-gas stream in the cleaning tunnel using the suction installation.

10. The method according to claim 9,
wherein the processing apparatus includes a conveying device and wherein the conveying device has a direction of movement, further comprising conveying gas in a direction opposite the direction of movement of the conveying device using the suction installation.

11. The method according to claim 9, further comprising generating a directed blowing stream having a directional component in the direction of the purifying-gas stream using at least one blower nozzle.

12. The method according to claim 9, further comprising establishing a pressure differential between the second zone and the first zone by adjusting and maintaining pressures in the first zone and the second zone such that that the pressure inside a housing of the second zone is less than the pressure inside a housing of the first zone.

13. The method according to claim 12, further comprising providing a third zone and establishing a pressure cascade between the first zone, the second zone, and the third zone such that the pressure inside a housing of the third zone is less than the pressure inside the housing of the second zone.

14. The method according to claim 12, further comprising establishing a pressure in a surrounding region of the first zone that is equal to an atmospheric external pressure.

15. The method according to claim 9, further comprising decoupling the second system portion from the first system portion and, with the lock closed, moving the second system portion to a separate cleaning operation.

16. The processing system according to claim 2,
wherein the conveying device is a turntable.
